(19) United States
(12) Patent Application Publication
(10) Pub. No.: US 2016/0041681 A1
(43) Pub. Date: Feb. 11, 2016

(54) METHOD FOR DETECTING TOUCH PANEL POSITION, TOUCH PANEL CONTROLLER, TOUCH PANEL SYSTEM, AND ELECTRONIC DEVICE

(71) Applicant: SHARP KABUSHIKI KAISHA, Osaka (JP)

(72) Inventor: Mutsumi HAMAGUCHI, Osaka-shi (JP)

(73) Assignee: SHARP KABUSHIKI KAISHA, Osaka-shi, Osaka (JP)

(21) Appl. No.: 14/780,129

(22) PCT Filed: Apr. 2, 2014
(86) PCT No.: PCT/JP2014/059733

§ 371 Date: Sep. 25, 2015

(30) Foreign Application Priority Data
Apr. 5, 2013 (JP) 2013-079512

(51) Int. Cl. G06F 3/041; G06F 3/044; G06F 3/0354

(52) U.S. Cl. CPC G06F 3/0416; G06F 3/03545; G06F 3/044; G06F 2203/04106

(57) ABSTRACT

In order to detect a position of a stylus pen on a touch panel, a position of a stylus pen (15) in a vertical direction is detected based on M first pen signals output from signal lines (HL1 to HLM) by driving the stylus pen (15), and a position of the stylus pen (15) in a horizontal direction is detected based on M second pen signals output from signal lines (VL1 to VLM) by driving the stylus pen (15).

### TECHNICAL FIELD

The present invention relates to a method for detecting a touch panel position and a touch panel controller that detect a position of an input pen on a touch panel which has a plurality of electrostatic capacitances formed at respective intersections of a plurality of first signal lines and a plurality of second signal lines, and particularly relates to a method for detecting a touch panel position, a touch panel controller, a touch panel system and an electronic device that drive the plurality of first signal lines and the plurality of second signal lines alternately.

### BACKGROUND ART

A touch panel controller of the aforementioned type is described in PTL 1. In the conventional technique, the touch panel controller is configured as follows.

In order to detect distribution of a plurality of electrostatic capacitances formed at respective intersections of a plurality of first signal lines and a plurality of second signal lines, the touch panel controller first drives the first signal lines to output, from the second signal lines, a signal based on charges corresponding to the electrostatic capacitances. Then, connection of the first signal lines and the second signal lines is switched. Next, the second signal lines are driven to output, from the first signal lines, a signal based on the charges corresponding to the electrostatic capacitances.

With the aforementioned touch panel controller, the signal based on the charges corresponding to the electrostatic capacitances are able to be output from both of the first signal lines and the second signal lines, so that it is possible to eliminate an influence by electromagnetic noise which is input to a touch panel with a hand, a finger, or the like and superposed on a signal of a sense line.

### CITATION LIST

### Patent Literature

PTL 1: Japanese Unexamined Patent Application Publication No. 2013-008318 (Publication date: Jan. 10, 2013)

### SUMMARY OF INVENTION

### Technical Problem

According to the aforementioned configuration of the conventional technique, when an input pen touches the touch panel, a value of an electrostatic capacitance formed at a position corresponding to the touched position changes, and the change in the electrostatic capacitance value is then detected to determine the position touched by the input pen. In this case, a plurality of electrostatic capacitances output, along a sense line, a linear sum signal based on the charges accumulated by a driving signal input to a drive line. The input pen itself does not receive any signals and does not output any signals.

On the other hand, an active stylus pen that outputs a signal has drawn a lot of attentions in recent years. In addition, there is a desire of enhancing performance of a touch panel controller by applying the active stylus pen to the touch panel controller of an electrostatic capacitance type that drives the aforementioned first signal lines and the aforementioned second signal lines alternately.

An object of the invention is to provide a method for detecting a touch panel position and a touch panel controller capable of detecting a position of a stylus pen on a touch panel by driving the stylus pen.

### Solution to Problem

In order to solve the aforementioned problem, a method for detecting a touch panel position according to one aspect of the invention is a method for detecting a touch panel position for detecting a position of a stylus pen on a touch panel which has M first signal lines (M is plural) and K second signal lines (K is plural) which intersect with the M first signal lines, the method including: a first driving step of driving the stylus pen to obtain a first pen signal based on electrostatic capacitances between the stylus pen and the respective K second signal lines; a second driving step of driving the stylus pen to obtain a second pen signal based on electrostatic capacitances between the stylus pen and the respective M first signal lines; and a position detection step of detecting a position of the stylus pen along a first signal line based on the first pen signal obtained at the first driving step and detecting a position of the stylus pen along a second signal line based on the second pen signal obtained at the second driving step.

Moreover, in order to solve the aforementioned problem, a touch panel controller according to one aspect of the invention is a touch panel controller for detecting a position of a stylus pen on a touch panel which has M first signal lines (M is plural) and K second signal lines (K is plural) which intersect with the M first signal lines, the touch panel controller including: first driving means of driving the stylus pen to generate a first pen signal based on electrostatic capacitances between the stylus pen and the respective K second signal lines; second driving means of driving the stylus pen to generate a second pen signal based on electrostatic capacitances between the stylus pen and the respective M first signal lines; and position detection means of detecting a position of the stylus pen along a first signal line based on the first pen signal output from the stylus pen by the first driving means and detecting a position of the stylus pen along a second signal line based on the second pen signal output from the stylus pen by the second driving means.

Moreover, in order to solve the aforementioned problem, a touch panel controller according to one aspect of the invention is a touch panel controller for detecting positions of first and second stylus pens on a touch panel which has M first signal lines (M is plural) and K second signal lines (K is plural) which intersect with the M first signal lines, the touch panel controller including: first driving means of driving the first stylus pen to generate a first pen signal based on electrostatic capacitances between the first stylus pen and the respective K second signal lines; second driving means of driving the first stylus pen to generate a second pen signal based on electrostatic capacitances between the first stylus pen and the respective M first signal lines; and position detection means of detecting a position of the first stylus pen along a first signal line based on the first pen signal generated by the first driving means and detecting a position of the first stylus pen along a second signal line based on the second pen signal generated by the second driving means. The first driving means drives the second stylus pen to generate a third pen signal based on electrostatic capacitances between the second stylus pen and the respective K second signal lines, the second driving means drives the second stylus pen to generate a fourth pen signal based on electrostatic capacitances between the second stylus pen and the respective M first signal lines, and the position detection means detects a position of the second stylus pen along a first signal line based on the third pen signal generated by the first driving means and detects a position of the second stylus pen along a second signal line based on the fourth pen signal generated by the second driving means.

Moreover, in order to solve the aforementioned problem, a touch panel system according to one aspect of the invention is a touch panel system including a stylus pen for touching a touch panel which has M first signal lines (M is plural) and K second signal lines (K is plural) which intersect with the M first signal lines, and a touch panel controller that detects a position of the stylus pen, in which the touch panel controller includes: first driving means of driving the stylus pen to generate a first pen signal based on electrostatic capacitances between the stylus pen and the respective K second signal lines; second driving means of driving the stylus pen to generate a second pen signal based on electrostatic capacitances between the stylus pen and the respective M first signal lines; and position detection means of detecting a position of the stylus pen along a first signal line based on the first pen signal generated by the first driving means and detecting a position of the stylus pen along a second signal line based on the second pen signal generated by the second driving means.

### Advantageous Effects of Invention

According to one aspect of the invention, an effect is exerted that by detecting a position of the stylus pen along the first signal line in the first driving step and detecting a position of the stylus pen along the second signal line in the second driving step, a position of the stylus pen on the touch panel is able to be detected by driving the stylus pen.

### BRIEF DESCRIPTION OF DRAWINGS

FIG. 1 is a block diagram illustrating a configuration of a touch panel system according to an embodiment 1.

FIG. 2 is a schematic view illustrating a configuration of a touch panel provided in the touch panel system.

FIG. 3 is a circuit diagram illustrating a configuration of a multiplexer for switching connection of signal lines connected to the touch panel between drive lines connected to a driver and sense lines connected to a sense amplifier.

FIG. 4 is a circuit diagram illustrating a detailed configuration of the multiplexer.

FIG. 5 is a block diagram illustrating a configuration of a stylus pen provided in the touch panel system.

FIG. 6 is a timing waveform diagram for explaining a method for synchronizing operation of the stylus pen on the touch panel and operation of the touch panel.

FIG. 7 is a block diagram illustrating configurations of a multiplexer and a changeover circuit of a touch panel system according to a modified example of the embodiment 1.

FIG. 8 is a block diagram illustrating a configuration of a touch panel system according to another modified example of the embodiment 1.

FIG. 9 is a block diagram illustrating a configuration of a touch panel system according to an embodiment 2.

FIG. 10 is a view for explaining a mechanism of parallel driving of the touch panel system.

FIG. 11(a) is a view for explaining driving by m-sequences of the touch panel system and FIG. 11(b) is a view for explaining driving in which driving codes of the m-sequences are inverted.

FIG. 12(a) is a view for explaining driving of the touch panel system by an Hadamard matrix and FIG. 12(b) is a view for explaining driving in which a driving code of the Hadamard matrix is inverted.

FIG. 13 is a view for explaining operation of a touch panel system of a successive driving method.

FIG. 14 is a view for explaining a part of operation of a touch panel system according to an embodiment 3.

FIG. 15 is a view for explaining a remaining part of the operation of the touch panel system.

FIG. 16 is a block diagram illustrating a configuration of a mobile phone according to an embodiment 4.

### DESCRIPTION OF EMBODIMENTS

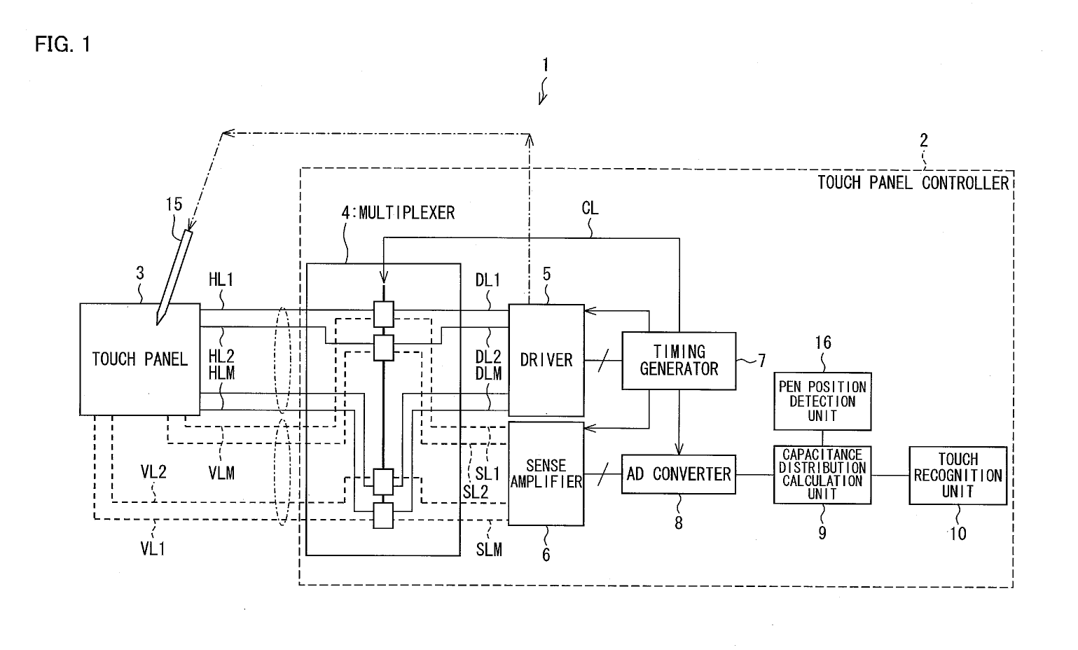

Embodiments of the invention will hereinafter be described in detail based on FIG. 1 to FIG. 16.

### Embodiment 1

An embodiment 1 of the invention will be described based on FIG. 1 to FIG. 6 as follows.

### (Configuration of Touch Panel System 1)

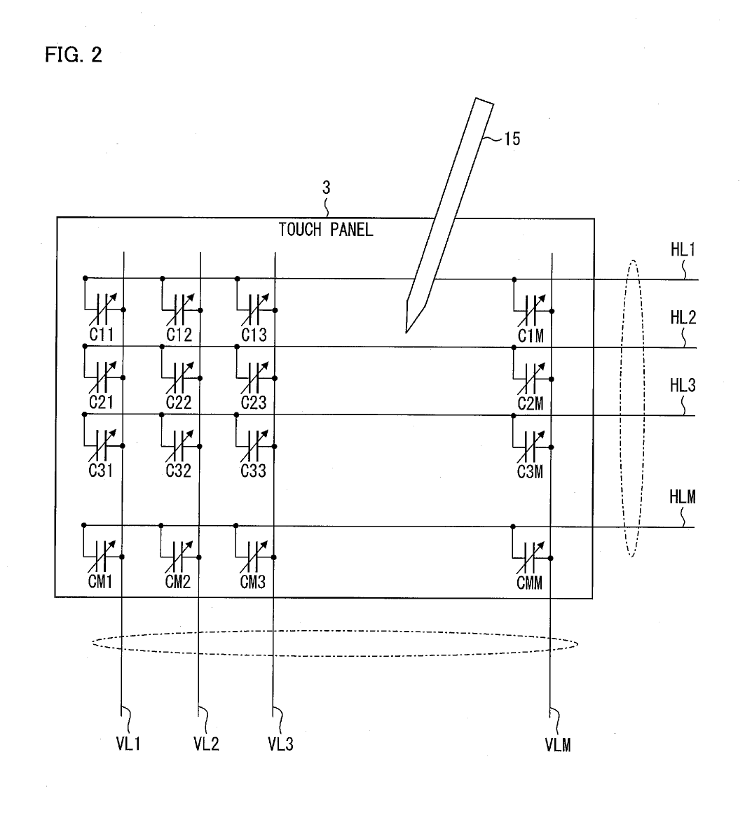

FIG. 1 is a block diagram illustrating a configuration of a touch panel system 1 according to the embodiment 1. FIG. 2 is a schematic view illustrating a configuration of a touch panel 3 provided in the touch panel system 1.

The touch sensor system 1 includes the touch panel 3, a touch panel controller 2, and a stylus pen 15. The touch panel 3 includes a plurality of signal lines VL1 to VLM (second signal lines) which are arranged in parallel to each other along a vertical direction, a plurality of signal lines HL1 to HLM (first signal lines) which are arranged in parallel to each other along a horizontal direction, and electrostatic capacitances C11 to CMM which are respectively formed at intersections of the signal lines HL1 to HLM and the signal lines VL1 to VLM. The touch panel 3 preferably has an area in which a hand gripping the stylus pen 15 is able to be put, but may have a size used for a smartphone.

The touch panel controller 2 includes a driver 5. The driver 5 applies voltage to drive lines DL1 to DLM based on M coded sequences among (M+1) coded sequences having a length N, and applies voltage to the stylus pen 15 which is connected by cable based on the remaining one coded sequence among the (M+1) coded sequences. Alternatively, a sense circuit, a synchronization circuit and a drive circuit may be mounted in the stylus pen 15, and the stylus pen 15 in synchronization with the touch panel controller 2 drives the stylus pen 15 by using the drive circuit which is mounted in the stylus pen 15.

The touch panel controller 2 is provided with a sense amplifier 6. In a first driving step, the sense amplifier 6 reads, through sense lines SL1 to SLM, a linear sum signal corresponding to charges corresponding to the respective electrostatic capacitances C11 to CMM and charges corresponding to electrostatic capacitances between the stylus pen 15 and the respective M signal lines VL1 to VLM (first pen signal) to supply to an AD converter 8.

In a second driving step, the sense amplifier 6 reads, through the sense lines SL1 to SLM, a linear sum signal corresponding to the charges corresponding to the respective electrostatic capacitances C11 to CMM and charges corresponding to electrostatic capacitances between the stylus pen 15 and the respective M signal lines HL1 to HLM (second pen signal) to supply to the AD converter 8.

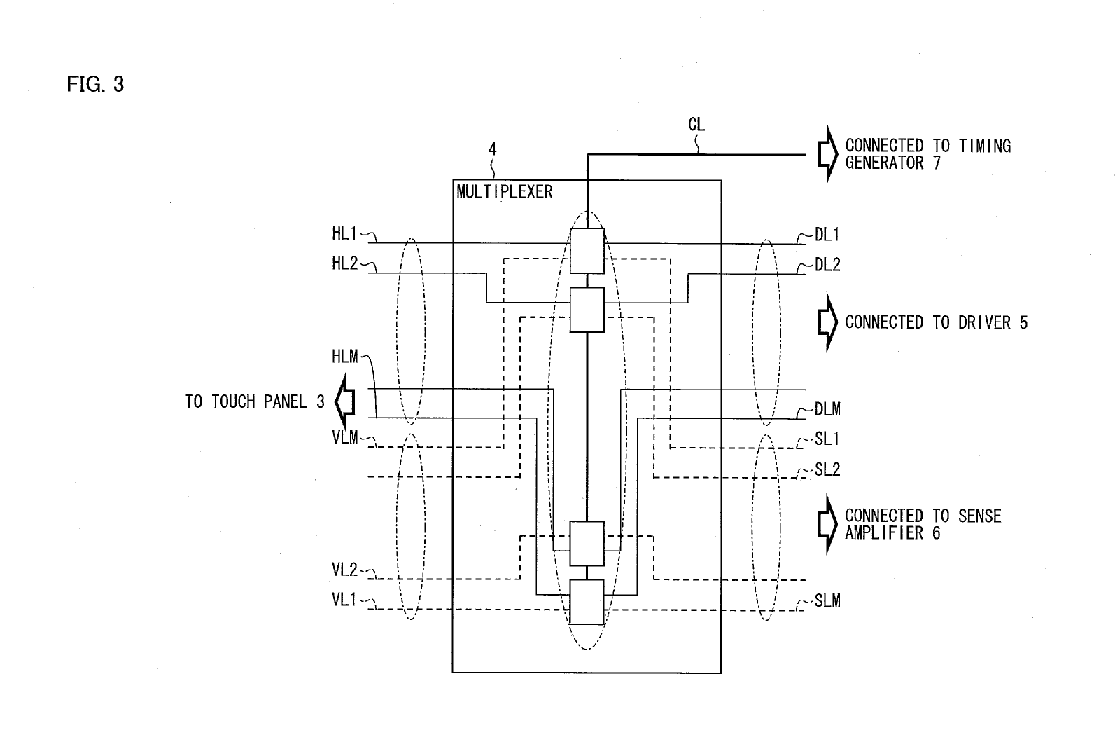

The touch panel controller 2 has a multiplexer 4. FIG. 3 is a circuit view illustrating a configuration of a connection switching circuit of the signal lines HL1 to HLM and VL1 to VLM connected to the touch panel 3 between the drive lines DL1 to DLM connected to the driver 5 and the sense lines SL1 to SLM connected to the sense amplifier 6.

The multiplexer 4 switches a first connection state where the signal lines HL1 to HLM are connected to the drive lines DL1 to DLM of the driver 5 and the signal lines VL1 to VLM are connected to the sense lines SL1 to SLM of the sense amplifier 6, and a second connection state where the signal lines HL1 to HLM are connected to the sense lines SL1 to SLM of the sense amplifier 6 and the signal lines VL1 to VLM are connected to the drive lines DL1 to DLM of the driver 5.

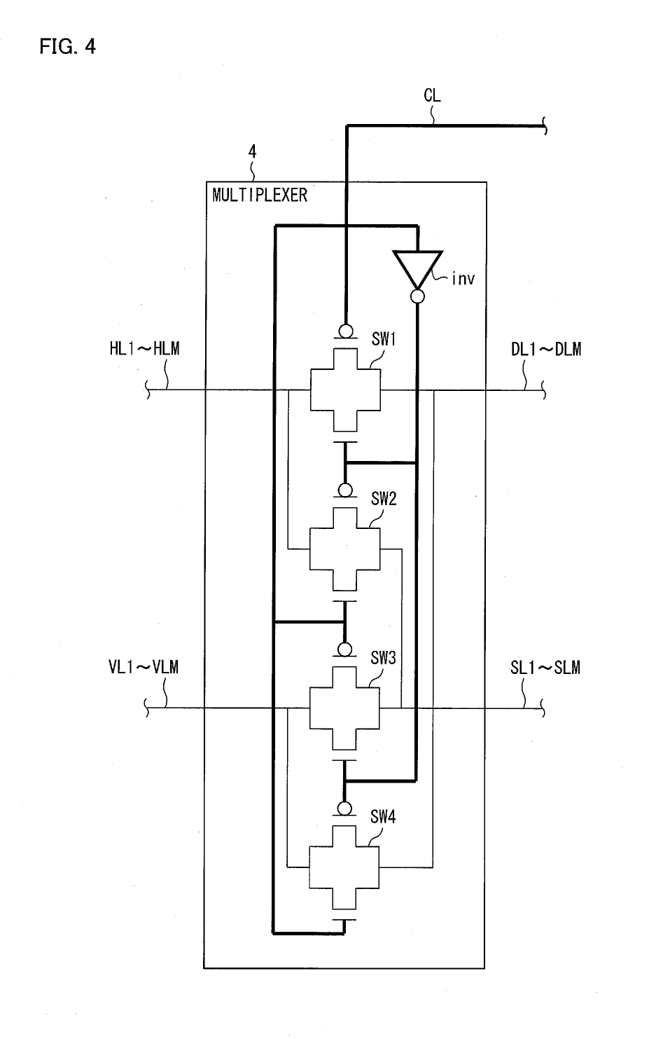

FIG. 4 is a circuit diagram illustrating a configuration of the multiplexer 4 provided in the touch panel controller 2 of the touch sensor system 1. The multiplexer 4 has four CMOS switches SW1 to SW4 which are connected in series. A control line CL from a timing generator 7 is connected to a gate of a PMOS of the CMOS switch SW1, a gate of an NMOS of the CMOS switch SW2, a gate of a PMOS of the CMOS switch SW3, a gate of an NMOS of the CMOS switch SW4, and an input of an inverter inv. An output of the inverter inv is connected to a gate of an NMOS of the CMOS switch SW1, a gate of a PMOS of the CMOS switch SW2, a gate of an NMOS of the CMOS switch SW3, and a gate of a PMOS of the CMOS switch SW4. The signal lines HL1 to HLM are connected to the CMOS switches SW1 and SW2. The signal lines VL1 to VLM are connected to the CMOS switches SW3 and SW4. The drive lines DL1 to DLM are connected to the CMOS switches SW1 and SW4. The sense lines SL1 to SLM are connected to the CMOS switches SW2 and SW3.

When a signal of the control line CL is set to be Low, the signal lines HL1 to HLM are connected to the drive lines DL1 to DLM and the signal lines VL1 to VLM are connected to the sense lines SL1 to SLM. When the signal of the control line CL is set to be High, the signal lines HL1 to HLM are connected to the sense lines SL1 to SLM and the signal lines VL1 to VLM are connected to the drive lines DL1 to DLM.

In the first driving step, the AD converter 8 performs AD conversion for the linear sum signal corresponding to the charges corresponding to the respective electrostatic capacitances C11 to CMM and the charges corresponding to the electrostatic capacitances between the stylus pen 15 and the respective M signal lines VL1 to VLM (first pen signal), which are read through the signal lines VL1 to VLM and the sense lines SL1 to SLM, to supply to a capacitance distribution calculation unit 9.

In the second driving step, the AD converter 8 performs AD conversion for the linear sum signal corresponding to the charges corresponding to the respective electrostatic capacitances C11 to CMM and the charges corresponding to the electrostatic capacitances between the stylus pen 15 and the respective M signal lines HL1 to HLM (second pen signal), which are read through the signal lines HL1 to HLM and the sense lines SL1 to SLM, to supply to the capacitance distribution calculation unit 9.

Based on the aforementioned linear sum signals including the first pen signal and the second pen signal, and the aforementioned (M+1) coded sequences having the length N, the capacitance distribution calculation unit 9 calculates distribution of the electrostatic capacitances on the touch panel 3, distribution of the electrostatic capacitances between the stylus pen 15 and the respective M signal lines VL1 to VLM, and distribution of the electrostatic capacitances between the stylus pen 15 and the respective M signal lines HL1 to HLM, and supplies the distribution of the electrostatic capacitances on the touch panel 3 to a touch recognition unit 10, and supplies the distribution of the electrostatic capacitances between the stylus pen 15 and the respective M signal lines VL1 to VLM and the distribution of the electrostatic capacitances between the stylus pen 15 and the respective M signal lines HL1 to HLM to a pen position detection unit 16 (position detection means). The touch recognition unit 10 recognizes a touched position on the touch panel 3 based on the distributions of the electrostatic capacitances supplied from the capacitance distribution calculation unit 9.

The pen position detection unit 16 detects a position of the stylus pen 15 along the signal line HL1 based on the distribution of the electrostatic capacitances between the stylus pen 15 and the respective M signal lines VL1 to VLM. The pen position detection unit 16 further detects a position of the stylus pen 15 along the signal line VL1 based on the distribution of the electrostatic capacitances between the stylus pen 15 and the respective M signal lines HL1 to HLM.

The touch panel controller 2 has the timing generator 7. The timing generator 7 generates a signal defining operation of the driver 5, a signal defining operation of the sense amplifier 6 and a signal defining operation of the AD converter 8 to supply to the driver 5, the sense amplifier 6 and the AD converter 8.

When the sense circuit, the synchronization circuit and the drive circuit are mounted in the stylus pen 15 to synchronize the touch panel controller 2 without driving the stylus pen 15 by cable, the timing generator 7 generates a synchronization signal. At a time of synchronization, the touch panel controller 2 drives the touch panel 3 with a signal dedicated for synchronization. The stylus pen 15 obtains the signal from the touch panel 3 with the mounted sense circuit, and the signal is supplied to the synchronization circuit. Upon acquirement of synchronization of the synchronization circuit, the stylus pen 15 is driven at a driving timing which is determined in advance.

### (Operation of Touch Panel System 1)

First, in the first connection state where the signal lines HL1 to HLM are connected to the drive lines DL1 to DLM of the driver 5 and the signal lines VL1 to VLM are connected to the sense lines SL1 to SLM of the sense amplifier 6, the driver 5 applies voltage to the drive lines DL1 to DLM to drive the signal lines HL1 to HLM based on a first one of the M coded sequences among the (M+1) coded sequences having the length N, as well applies voltage to the stylus pen 15 by cable based on the remaining one coded sequence among the (M+1) coded sequences. Here, for simplification, description will be given by taking an example in which the stylus pen 15 is driven by cable.

Here, the first coded sequence among the (M+1) coded sequences having the length N forms a “first coded sequence” described in claims.

Then, M first linear sum signals based on the charges accumulated in the respective electrostatic capacitances C11 to CMM by the driving of the signal lines HL1 to HLM and the charges corresponding to the electrostatic capacitances between the stylus pen 15 and the respective M signal lines VL1 to VLM (first pen signal) are output from the respective M signal lines VL1 to VLM (first driving step). The sense amplifier 6 reads the M first linear sum signals including the first pen signal through the multiplexer 4 and the sense lines SL1 to SLM to supply to the AD converter 8. The AD converter 8 performs AD conversion for the M first linear sum signals including the first pen signal to output to the capacitance distribution calculation unit 9.

Next, the first connection state where the signal lines HL1 to HLM are connected to the drive lines DL1 to DLM of the driver 5 and the signal lines VL1 to VLM are connected to the sense lines SL1 to SLM of the sense amplifier 6 is switched to the second connection state where the signal lines HL1 to HLM are connected to the sense lines SL1 to SLM of the sense amplifier 6 and the signal lines VL1 to VLM are connected to the drive lines DL1 to DLM of the driver 5.

The driver 5 then applies voltage to the drive lines DL1 to DLM to drive the signal lines VL1 to VLM based on the M coded sequences among second (M+1) coded sequences, and applies voltage to the stylus pen 15 by cable based on the remaining one coded sequence among the second (M+1) coded sequences. Here, the second coded sequence among the (M+1) coded sequences having the length N forms a “second coded sequence” described in claims.

Then, M second linear sum signals based on the charges accumulated in the respective electrostatic capacitances C11 to CMM by the driving of signal lines VL1 to VLM and the charges corresponding to the electrostatic capacitances between the stylus pen 15 and the respective M signal lines HL1 to HLM (second pen signal) are output from the respective M signal lines HL1 to HLM (second driving step). The sense amplifier 6 reads the M second linear sum signals including the second pen signal through the multiplexer 4 and the sense lines SL1 to SLM to supply to the AD converter 8. The AD converter 8 performs AD conversion for the M second linear sum signals including the second pen signal to output to the capacitance distribution calculation unit 9.

Next, based on the aforementioned first linear sum signals including the first pen signal, the aforementioned second linear sum signals including the second pen signal and the (M+1) coded sequences, the capacitance distribution calculation unit 9 calculates distribution of the electrostatic capacitances on the touch panel 3 to supply to the touch recognition unit 10, and calculates a position of the stylus pen 15 along the signal line HL1 and a position of the stylus pen 15 along the signal line VL1 to supply to the pen position detection unit 16 (position detection step).

The touch recognition unit 10 then recognizes a touched position on the touch panel 3 based on the distribution of the electrostatic capacitances supplied from the capacitance distribution calculation unit 9. The pen position detection unit 16 detects the position of the stylus pen 15 on the touch panel 3 based on the position of the stylus pen 15 along the signal line HL1 and the position of the stylus pen 15 along the signal line VL1, which are calculated by the capacitance distribution calculation unit 9.

### (Configuration of Stylus Pen Operated by Radio)

As described above, though the example in which the stylus pen 15 is driven by cable has been described, a radio configuration may be provided that the stylus pen 15 is operated in synchronization with the touch panel controller 2 by radio.

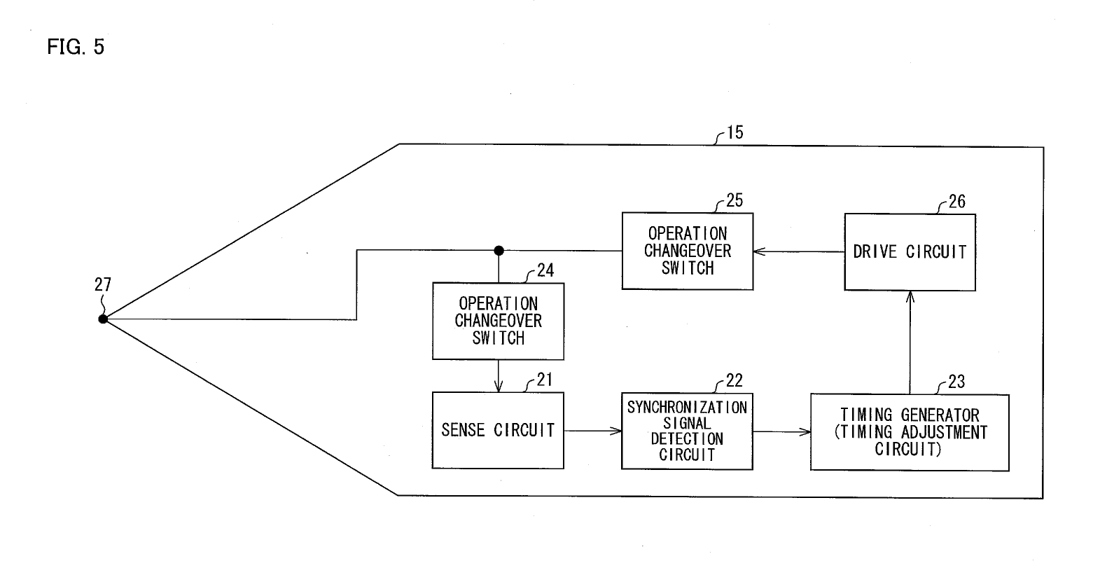

FIG. 5 is a block diagram illustrating a configuration of the stylus pen 15 which is operated by radio. The stylus pen 15 has a pen point 27, and includes a sense circuit 21, a synchronization signal detection circuit 22, a timing generator (timing adjustment circuit) 23, operation changeover switches 24 and 25, and a drive circuit 26.

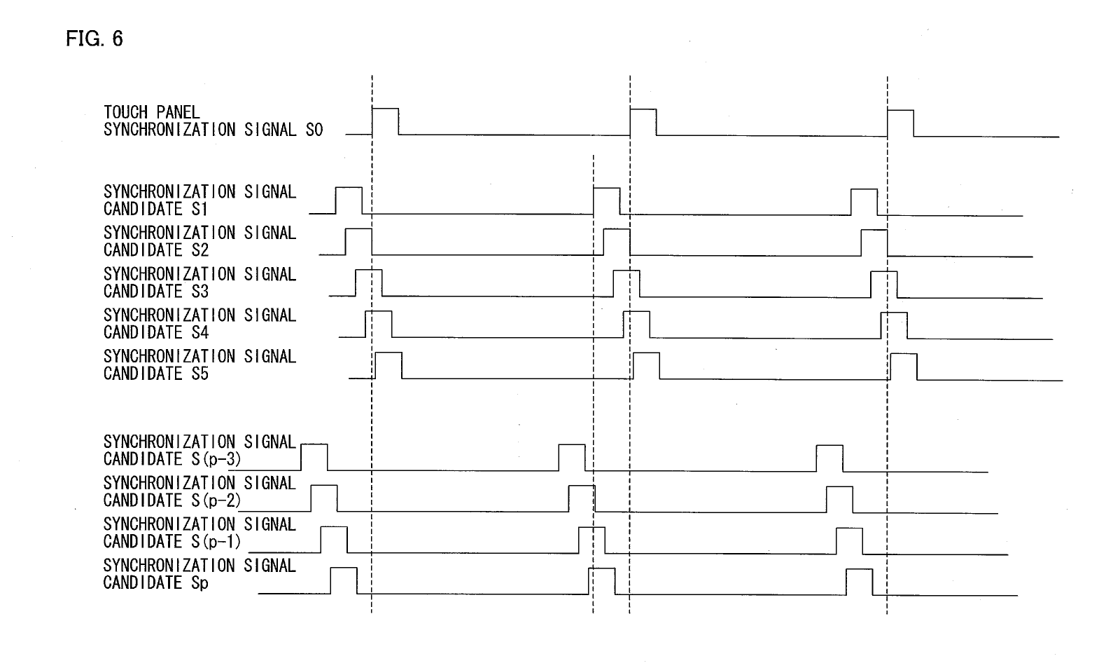

FIG. 6 is a timing waveform diagram for explaining a method for synchronizing operation of the stylus pen 15 and operation of the touch panel 3.

The stylus pen 15 has a sense mode for sensing a synchronization signal and a driving mode for driving the pen. The sense mode brings a state where the operation changeover switch 24 provided in the stylus pen 15 is turned on and the pen point 27 and the sense circuit 21 are connected, while the operation changeover switch 25 is turned off and the pen point 27 and the drive circuit 26 are not connected. A driving waveform of the touch panel 3 is then sensed by the sense circuit 21. The synchronization signal detection circuit 22 has a plurality of synchronization signal candidates S1 to Sp (p is an integer of 2 or more) inside thereof. Note that, the synchronization signal candidate Sp illustrated in FIG. 6 represents a signal in which the synchronization signal S1 is delayed by about one cycle.

The sense circuit 21 receives the synchronization signal, which is transmitted from the driver 5 of the touch panel controller 2, through the pen point 27 and the operation changeover switch 24 to supply to the synchronization signal detection circuit 22. The synchronization signal detection circuit 22 selects a synchronization signal having a high coincidence with the synchronization signal supplied from the sense circuit 21 from among the synchronization signal candidates S1 to Sp to adopt as a synchronization signal for communication with the touch panel controller 2. In the example illustrated in FIG. 6, the synchronization signal candidate S4 or S5 having a high coincidence with the driving waveform of the touch panel 3 which is driven (touch panel synchronization signal S0) is adopted as the synchronization signal. The stylus pen 15 is in the sense mode and is not driven until synchronization is acquired. It is considered that the synchronization signal candidate needs not only a phase deviation signal but also a synchronization deviation signal in consideration of deviation of a reference clock.

The driving mode brings a state where the operation changeover switch 25 is turned on and the pen point 27 and the drive circuit 26 are connected, while the operation changeover switch 24 is turned off and the pen point 27 and the sense circuit 21 are not connected. The synchronization signal detection circuit 22 supplies the adopted synchronization signal and information of the deviation of the reference clock to the timing generator 23. The timing generator 23 drives the drive circuit 26 so as to match with an operation timing of the touch panel controller 2 based on the synchronization signal and the information of the deviation of the reference clock. With a driving signal output from the drive circuit 26 through the operation changeover switch 25, the pen point 27 is driven.

Note that, in the case of the aforementioned operation of detecting the synchronization signal, the stylus pen 15 is desired to be capable of initial setting. When it is necessary to store the initial setting even after power is turned off, the stylus pen 15 needs a non-volatile memory. Further, a time interval of the synchronization signal of the touch panel controller 2 and the stylus pen 15 is desired to be initially set in advance.

### Effect

The aforementioned embodiment 1 exerts the following effect.

Since the capacitance distribution calculation unit 9 detects a position of the stylus pen 15 along the signal line HL1 and detects a position of the stylus pen 15 along the signal line VL1, it is possible to detect a position of the stylus pen 15 on the touch panel 3 by driving stylus pen 15.

### MODIFIED EXAMPLE

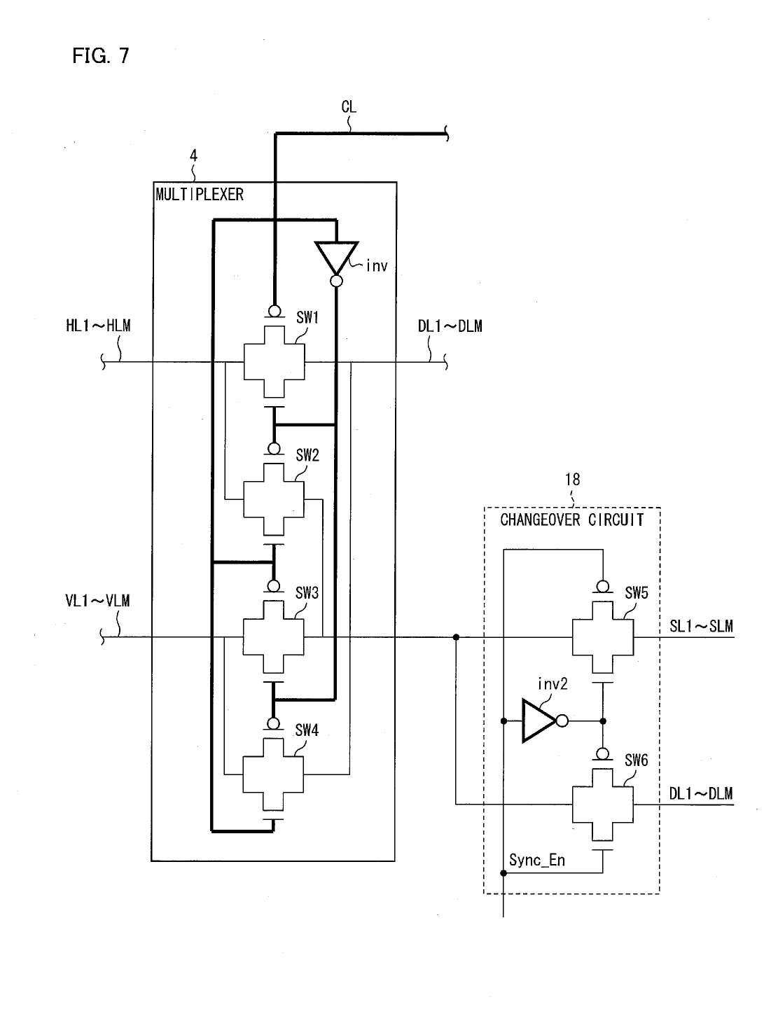

FIG. 7 is a block diagram illustrating configurations of the multiplexer 4 and a changeover circuit 18 of a touch panel system according to a modified example of the embodiment 1.

In order to facilitate the sense operation of the stylus pen 15, during the sense mode in which a synchronization signal is sensed, the touch panel controller 2 may be composed to drive an entire surface (the signal lines VL1 to VLM and the signal lines HL1 to HLM) of the touch panel 3. This is because it is possible to increase a level of a signal which is able to be obtained by the stylus pen 15 and the operation of the sense mode becomes more facilitated.

The changeover switch 18 has two CMOS switches SW5 to SW6 which are connected in series. A control line Sync En from the timing generator 7 is connected to a gate of a PMOS of the CMOS switch SW5, a gate of an NMOS of the CMOS switch SW6, and an input of an inverter inv2. An output of the inverter inv2 is connected to a gate of an NMOS of the CMOS switch SW5 and a gate of a PMOS of the CMOS switch SW6. The signal line from the multiplexer 4 is connected to the CMOS switches SW5 and SW6. The drive lines DL1 to DLM are connected to the CMOS switch SW6. The sense lines SL1 to SLM are connected to the CMOS switch SW5.

In a configuration where both of the signal lines VL1 to VLM and the signal lines HL1 to HLM of the touch panel 3 are driven, the driver 5 drives the signal lines VL1 to VLM and the signal lines HL1 to HLM at the same time through the drive line DL1 to DLM. As illustrated in FIG. 7, the changeover circuit 18 is added. The changeover circuit 18 connects the drive lines DL1 to DLM to the multiplexer 4 when the touch panel controller 2 outputs the synchronization signal to the stylus pen 15 (sense mode). As a result thereof, the drive lines DL1 to DLM are able to be connected to both of the signal lines VL1 to VLM and the signal lines HL1 to HLM.

At a timing of collecting capacitance information (when carrying out the first driving step and the second driving step, when carrying out first driving means and second driving means (driving mode)), the sense lines SL1 to SLM are connected to the multiplexer 4 by the changeover circuit 18. As a result thereof, the first connection state where the drive lines DL1 to DLM are connected to the signal lines HL1 to HLM and the sense lines SL1 to SLM are connected to the signal lines VL1 to VLM and the second connection state where the drive lines DL1 to DLM are connected to the signal lines VL1 to VLM and the sense lines SL1 to SLM are connected to the signal lines HL1 to HLM are switched by the multiplexer 4.

### Another Modified Example

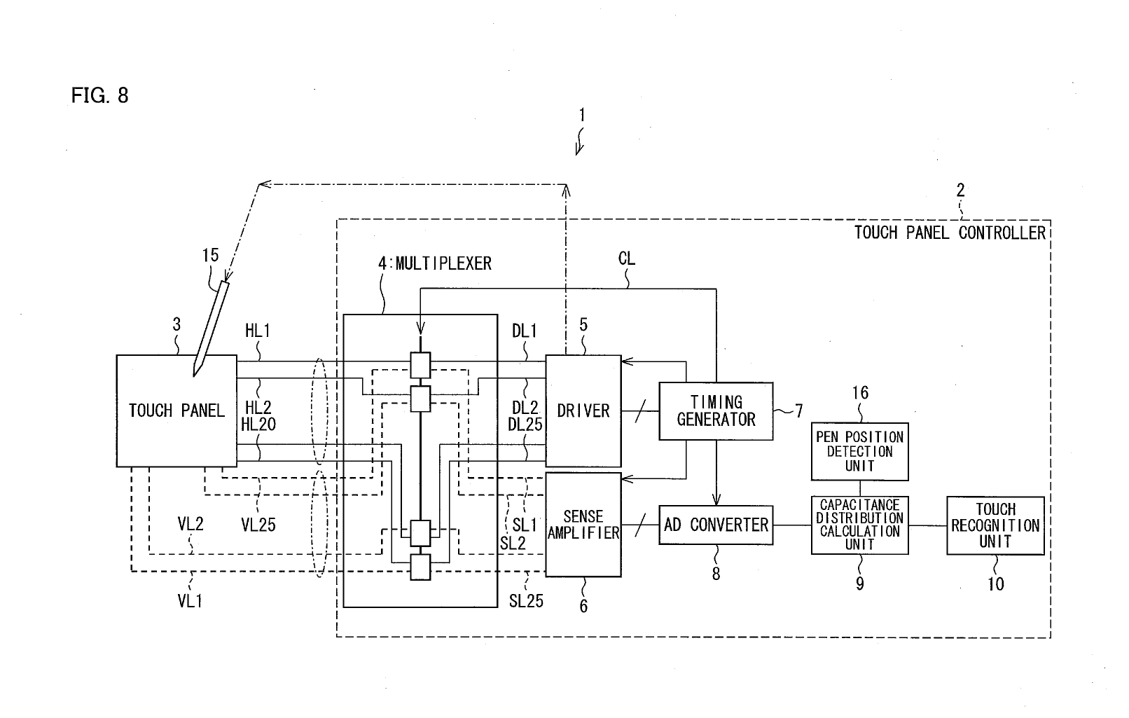

FIG. 8 is a block diagram illustrating a configuration of a touch panel system 1 according to another modified embodiment of the embodiment 1. Note that, for convenience of description, the same reference signs are assigned to members having the same functions as those of the members described in FIG. 1 above and description thereof will be omitted.

In the example illustrated in FIG. 1, illustrated is an example in which the number of the signal lines in the horizontal direction and the number of the signal lines in the vertical direction are the same (M) in the touch panel 3. However, the invention is not limited thereto. The number of the signal lines in the horizontal direction and the number of the signal lines in the vertical direction may be different.

The touch panel 3 illustrated in FIG. 8 has twenty-five signal lines VL1 to VL25 and twenty signal lines HL1 to HL20. Twenty-five drive lines DL1 to DL25 are connected to the driver 5 and twenty-five sense lines SL1 to SL25 are connected to the sense amplifier 6.

In such a case, in the first connection state, the driver 5 applies voltage to the drive lines DL1 to DL20 to drive the signal lines HL1 to HL20 based on twenty coded sequences among twenty-one coded sequences, and drives the stylus pen 15 by cable based on the remaining one coded sequence among the twenty-one coded sequences. Note that, as described above with reference to FIG. 5, a radio configuration may be provided that the stylus pen 15 includes the sense circuit 21, the synchronization signal detection circuit 22, the timing generator (timing adjustment circuit) 23, the operation changeover switches 24 and 25, and the drive circuit 26 so as to operate in synchronization with the touch panel controller 2 by radio. Here, the twenty-one coded sequences correspond to the “first coded sequences” described in claims.

The capacitance distribution calculation unit 9 then estimates a touch position of the stylus pen 15 along the horizontal direction based on distribution of electrostatic capacitances between the stylus pen 15 and the respective signal lines VL1 to VL25.

Next, in the second connection state, the driver 5 applies voltage to the drive lines DL1 to DL25 to drive the signal lines VL1 to VL25 based on twenty-five coded sequences among twenty-six coded sequences, and drives the stylus pen 15 by cable based on the remaining one coded sequence among the twenty-six coded sequences. Here, the twenty-six coded sequences correspond to the “second coded sequences” described in claims.

Thereafter, the capacitance distribution calculation unit 9 estimates a touch position of the stylus pen 15 along the vertical direction based on distribution of electrostatic capacitances between the stylus pen 15 and the respective signal lines HL1 to HL20.

### Embodiment 2

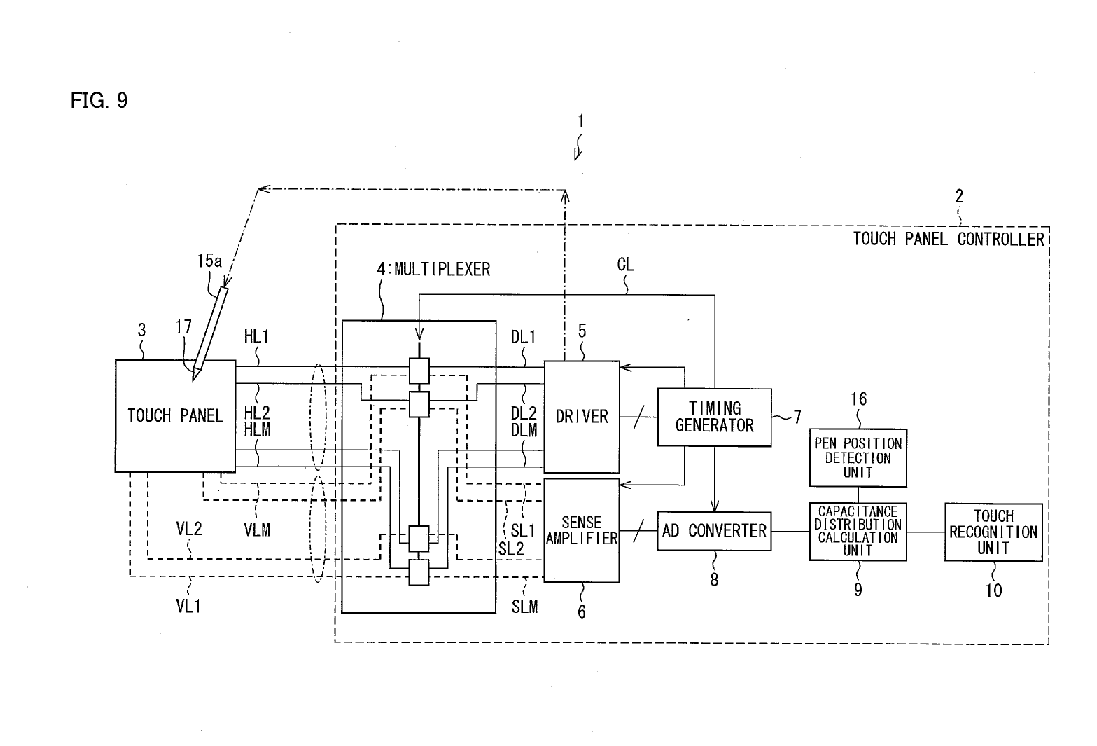

An embodiment 2 of the invention will be described based on FIG. 9 to FIG. 12 as follows. FIG. 9 is a block diagram illustrating a configuration of a touch panel system 1 according to the embodiment 2. Note that, for convenience of description, the same reference signs are assigned to members having the same functions as those of the members described in the aforementioned embodiment and description thereof will be omitted. The same is applied to embodiments described below.

A stylus pen 15a has a pressure sensor 17 for detecting writing pressure. The driver 5 is connected to the stylus pen 15a by cable. Note that, as described above with reference to FIG. 5, a radio configuration may be provided that the stylus pen 15a includes the sense circuit 21, the synchronization signal detection circuit 22, the timing generator (timing adjustment circuit) 23, the operation changeover switches 24 and 25, and the drive circuit 26 so as to operate in synchronization with the touch panel controller 2 by radio. The drive circuit 26 is mounted in the stylus pen 15a and a polarity of a coded sequence is inverted based on an output of the pressure sensor 17 mounted in the stylus pen 15a.

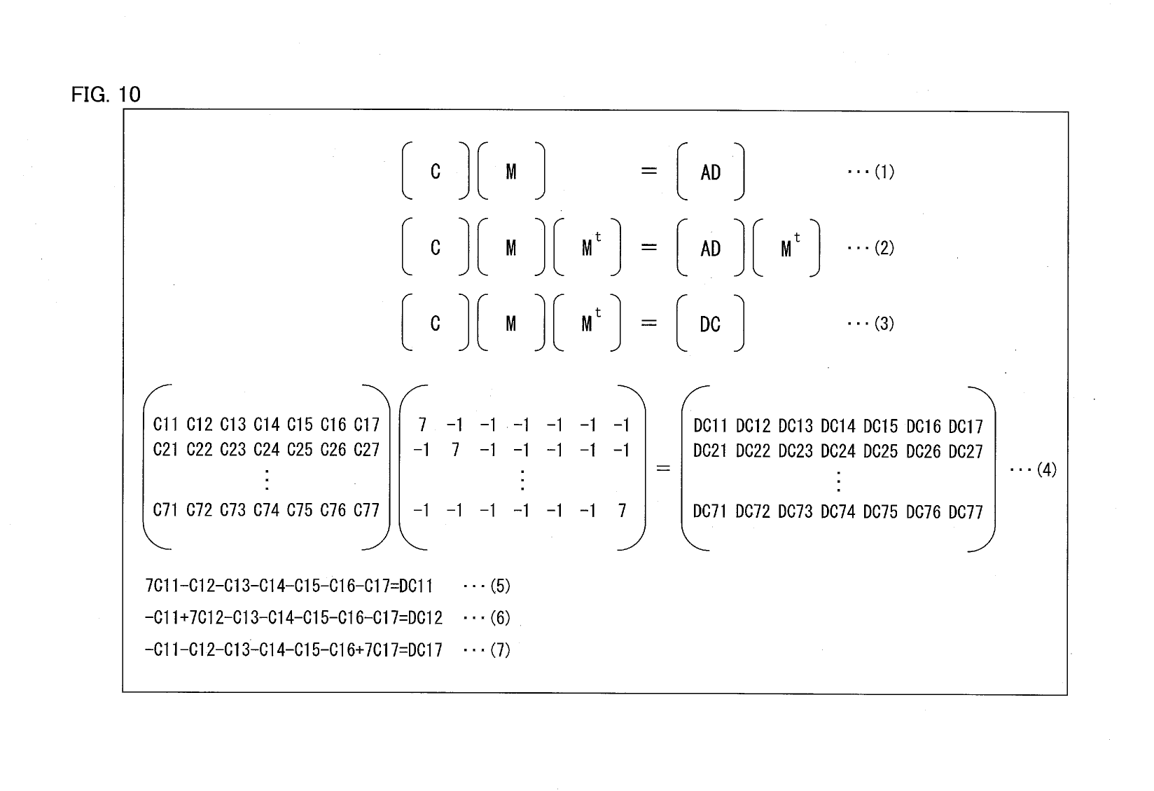

FIG. 10 is a view for explaining a mechanism of parallel driving of the touch panel system 1. When a C matrix representing distribution of electrostatic capacitances is driven by an M matrix representing codes of m-sequences, an AD matrix illustrated in a right side of a formula 1 is obtained. As illustrated in a formula 2 and a formula 3, a DC matrix is calculated by multiplying the AD matrix obtained by the formula 1 by a transposed matrix of the M matrix. A formula 4 is obtained by representing the formula 3 specifically. Accordingly, a correlation between the DC matrix obtained by multiplying the AD matrix by the transposed matrix of the M matrix and the C matrix, for example, as to DC11, DC12, and DC 17 is represented by a formula 5, a formula 6, and a formula 7, respectively.

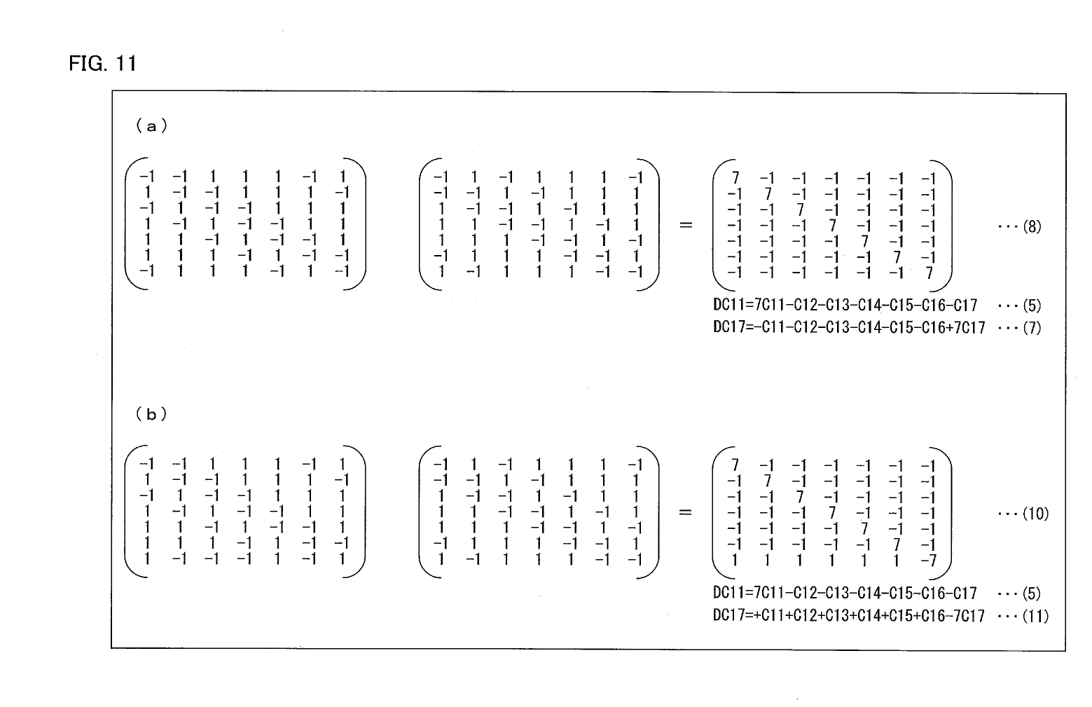

FIG. 11(a) is a view for explaining driving by the m-sequences of the touch panel system 1 and (b) is a view for explaining driving in which driving codes of the m-sequences are inverted.

A left matrix of a left side of a formula 8 indicates the M matrix and a right matrix of the left side indicates the transposed matrix (matrix for decoding) of the M matrix. A left matrix of a left side of a formula 10 indicates a matrix in which a driving code in a seventh row of the M matrix is inverted. A right matrix of the left side indicates the transposed matrix (matrix for decoding) of the M matrix. A correlation between the DC matrix and the C matrix, for example, as to DC11 is represented by the formula 5. DC 17 is represented by a formula 11 and a polarity is inverted to that of the formula 7.

In a hover state where the stylus pen 15a slightly hovers from the touch panel 3, the stylus pen 15a is driven by a code of the M matrix expressed in the formula 8. When the pressure sensor 17 senses pressure when the stylus pen 15a makes contact with the touch panel 3, the drive circuit mounted in the stylus pen 15a drives the stylus pen 15a by inverting a driving code for the stylus pen 15a of the M matrix as expressed in the formula 10.

By providing a configuration in which a memory having past capacitance distribution stored therein is mounted in the touch panel controller 2 so as to compare current capacitance distribution and the past capacitance distribution, it is found that a polarity of a signal of a coded sequence allocated to the stylus pen 15a is inverted. Generally, as a distance between the stylus pen 15a and the touch panel 3 becomes short, an electrostatic capacitance changes in an increasing direction. When the direction in which the electrostatic capacitance increases is known in advance, a polarity of an output value is known in advance.

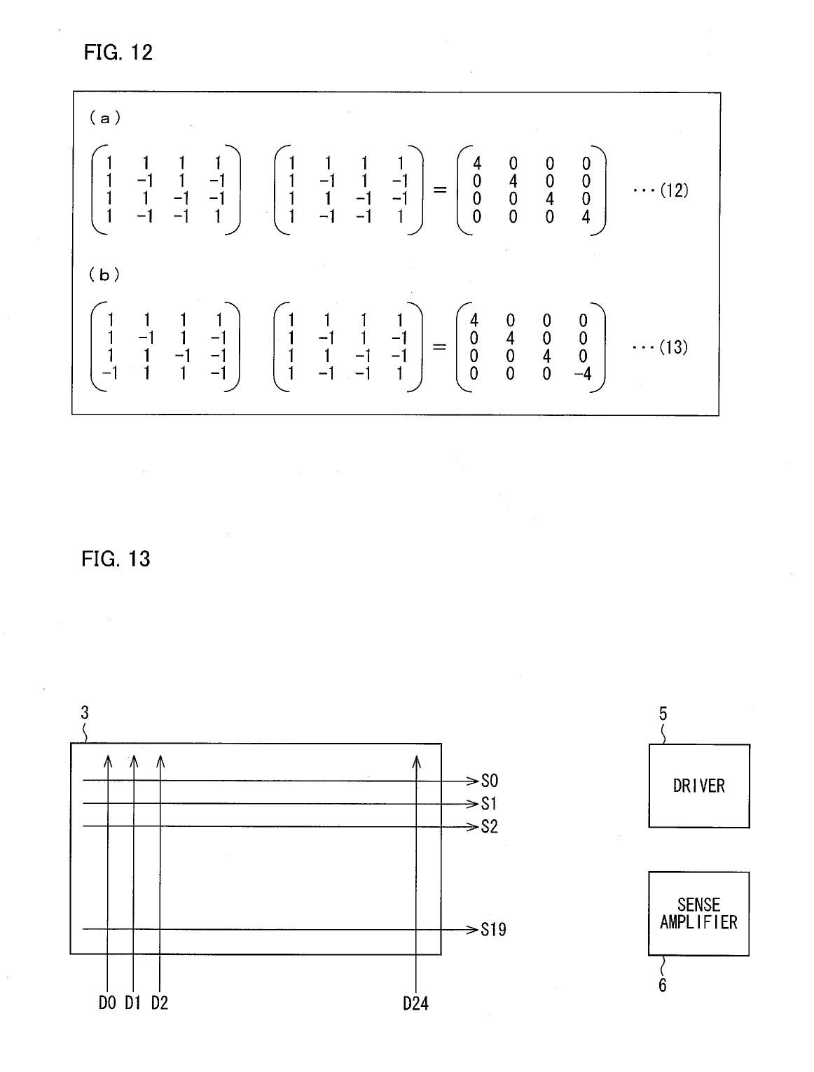

FIG. 12(a) is a view for explaining driving of the touch panel system 1 by an Hadamard matrix and (b) is a view for explaining driving in which a driving code of the Hadamard matrix is inverted.

In FIG. 11 above, a case where the m-sequences are used for inversion of the polarity when the driving code is inverted has been described. However, the invention is not limited thereto. It is easily recognized by referring to a formula 12 and a formula 13 of FIG. 12 that similar inversion is performed also when the Hadamard matrix is used.

(Configuration in which a Plurality of Stylus Pens are Provided)

For simplification, description has been given in the foregoing examples by exemplifying a case where there is one stylus pen. However, the invention is not limited thereto. Usage with similar principle is possible even when there are a plurality of stylus pens.

For example, when two stylus pens are desired to be used in a state of the embodiment 1, it may be configured so that the driver 5 applies voltage to the drive lines DL1 to DLM based on first M coded sequences among (M+2) coded sequences having the length N to drive the signal lines HL1 to HLM, and applies voltage to the stylus pen 15 by cable based on one of the remaining coded sequences among the (M+2) coded sequences, and applies voltage to the remaining stylus pen 15 based on the other one remaining coded sequence.

For simplification, though the stylus pens have been described here by exemplifying driving by cable, as described above with reference to FIG. 5, a radio configuration may be provided that each of the stylus pens includes the sense circuit 21, the synchronization signal detection circuit 22, the timing generator (timing adjustment circuit) 23, the operation changeover switches 24 and 25, and the drive circuit 26 so as to operate in synchronization with the touch panel controller by radio.

### Embodiment 3

An embodiment 3 of the invention will be described based on FIG. 13 to FIG. 15 as follows.

FIG. 13 is a view for explaining operation of a touch panel system of a successive driving method. The touch panel system includes the touch panel 3, the driver 5, and the sense amplifier 6. The touch panel 3 has twenty-five drive lines D0 to D24 extending in the vertical direction and twenty sense lines S0 to S19 extending in the horizontal direction. The driver 5 selects the drive lines D0, D1, D2, . . . , and D24 in this order for driving.

With respect to each of the sense lines S0, S1, . . . , and S19, the sense amplifier 6 outputs a signal based on charges of electrostatic capacitances between the respective sense lines S0 to S19 and the drive line D0 to the sense amplifier 6 at a timing where the drive line D0 is driven, and outputs a signal based on charges of electrostatic capacitances between the respective sense lines S0 to S19 and the drive line D1 to the sense amplifier 6 at a timing where the drive line D1 is driven. Subsequently, the sense amplifier 6 similarly outputs a signal based on charges of electrostatic capacitances between the respective sense lines S0 to S19 and the drive line D24 to the sense amplifier 6 at a timing where the drive line D24 is driven.

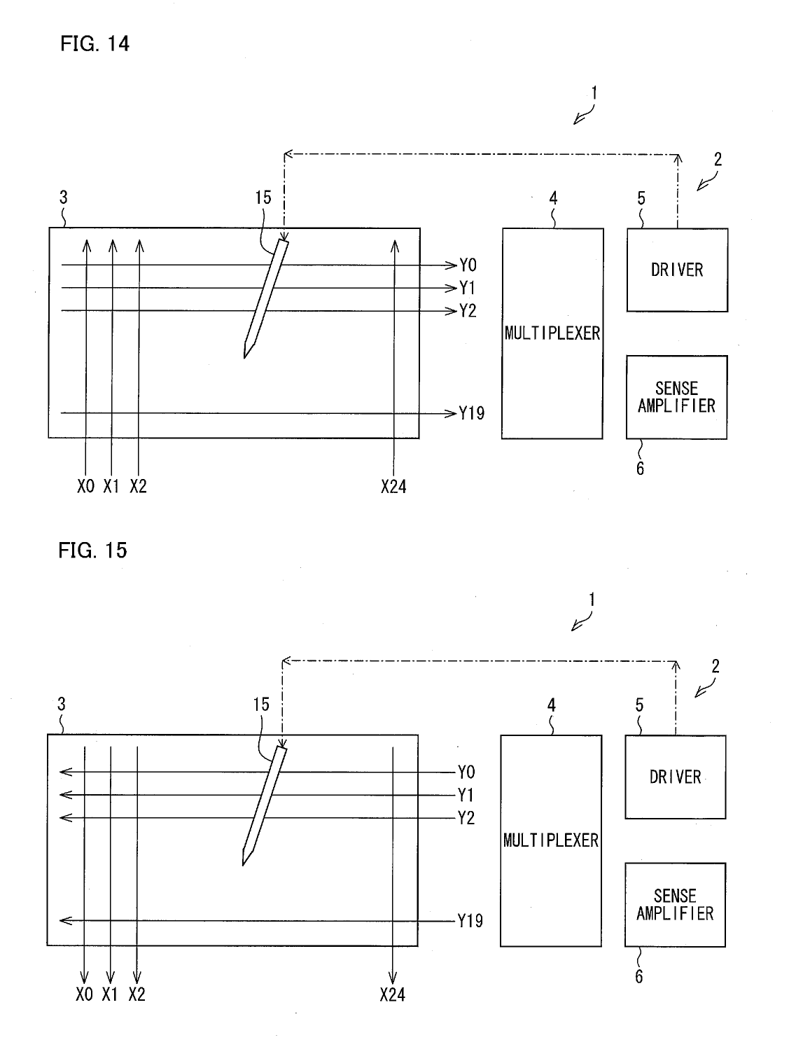

FIG. 14 is a view for explaining a part of operation of a touch panel system 1 according to the embodiment 3. The touch panel system 1 includes the touch panel 3, the multiplexer 4, the driver 5, and the sense amplifier 6. The touch panel 3 has twenty-five signal lines X0 to X24 extending in the vertical direction and twenty signal lines Y0 to Y19 extending in the horizontal direction. The multiplexer 4 first connects the signal lines X0 to X24 with the driver 5 and connects the signal lines Y0 to Y19 with the sense amplifier 6. Next, the driver 5 drives the signal lines X0 to X24 in order through the multiplexer 4. After driving the signal line X24, the driver 5 drives the stylus pen 15 by cable. Note that, as described above with reference to FIG. 5, a radio configuration may be provided that the stylus pen 15 includes the sense circuit 21, the synchronization signal detection circuit 22, the timing generator (timing adjustment circuit) 23, the operation changeover switches 24 and 25, and the drive circuit 26 so as to operate in synchronization with the touch panel controller 2 by radio.

With respect to each of the signal lines Y0, Y1, . . . , and Y19, the sense amplifier 6 receives a signal based on charges of electrostatic capacitances between the respective signal lines Y0 to Y19 and the signal line X0 through the multiplexer 4 at a timing where the signal line X0 is driven, and receives a signal based on charges of electrostatic capacitances between the respective signal lines Y0 to Y19 and the signal line X1 through the multiplexer 4 at a timing where the signal line X1 is driven. Subsequently, the sense amplifier 6 similarly receives a signal based on charges of electrostatic capacitances between the respective signal lines Y0 to Y19 and the signal line X24 through the multiplexer 4 at a timing where the signal line X24 is driven. Then, at a timing where the stylus pen 15 is driven, a first pen signal based on electrostatic capacitances between the stylus pen 15 and the respective signal lines Y0 to Y19 is received through the multiplexer 4.

Thereby, distribution of the electrostatic capacitances in the entire surface of the touch panel 3 and a position of the stylus pen 15 in the vertical direction are found.

FIG. 15 is a view for explaining a remaining part of the operation of the touch panel system 1.

The multiplexer 4 connects the signal lines X0 to X24 with the sense amplifier 6 and connects the signal lines Y0 to Y19 with the driver 5. Next, the driver 5 drives the signal lines Y0 to Y19 in order through the multiplexer 4. After driving the signal line Y19, the driver 5 drives the stylus pen 15 by cable.

With respect to each of the signal lines X0, X1, . . . , and Y24, the sense amplifier 6 receives a signal based on charges of electrostatic capacitances between the respective signal lines X0 to X24 and the signal line Y0 through the multiplexer 4 at a timing where the signal line Y0 is driven, and receives a signal based on charges of electrostatic capacitances between the respective signal lines X0 to X24 and the signal line Y1 through the multiplexer 4 at a timing where the signal line Y1 is driven. Subsequently, the sense amplifier 6 similarly receives a signal based on charges of electrostatic capacitances between the respective signal lines X0 to X24 and the signal line Y19 through the multiplexer 4 at a timing where the signal line Y19 is driven. Then, at a timing where the stylus pen 15 is driven, a signal based on electrostatic capacitances between the stylus pen 15 and the respective signal lines X0 to X24 is received through the multiplexer 4.

Thereby, distribution of the electrostatic capacitances in the entire surface of the touch panel 3 and a position of the stylus pen 15 in the horizontal direction are found.

Accordingly, with the aforementioned position of the stylus pen 15 in the vertical direction and the aforementioned position of the stylus pen 15 in the horizontal direction, an X coordinate and a Y coordinate of the stylus pen 15 on the touch panel 3 are found.

### Embodiment 4

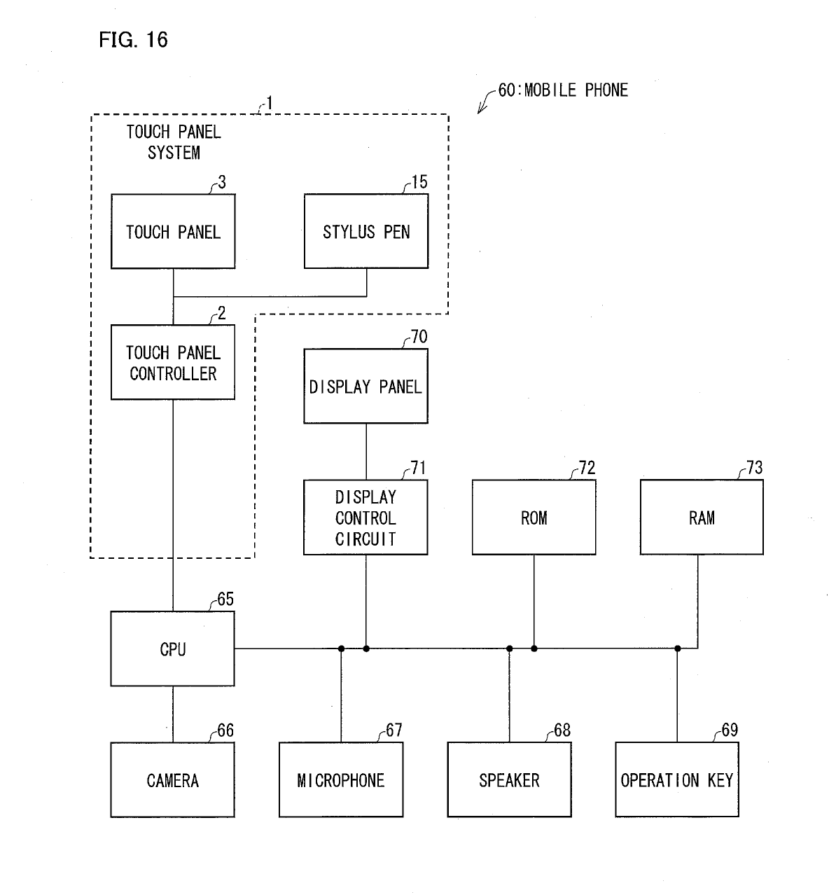

An embodiment 4 of the invention will be described based on FIG. 16 as follows. FIG. 15 is a block diagram illustrating a configuration of a mobile phone 60 according to the embodiment 4.

The mobile phone 60 includes a CPU 65, a RAM 73, a ROM 72, a camera 66, a microphone 67, a speaker 68, an operation key 69, a display panel 70, a display control circuit 71, and the touch panel system 1. Respective components are mutually connected by a data bus.

The CPU 65 controls operation of the mobile phone 60. The CPU 65 executes, for example, a program stored in the ROM 72. The operation key 69 receives an input of an instruction by a user of the mobile phone 60. The RAM 73 stores data which is generated by execution of the program by the CPU 65 or data which is input through the operation key 69, in a volatile manner. The ROM 72 stores data in a non-volatile manner.

Further, the ROM 72 is a ROM which allows writing and deletion, such as an EPROM (Erasable Programmable Read-Only Memory) or a flash memory. Note that, though not illustrated in FIG. 15, the mobile phone 60 may be composed to include an interface (IF) for being connected with another electronic device by cable.

The camera 66 photographs an object according to operation of the operation key 69 by the user. Image data of the object which is photographed is stored in the RAM 73 or an external memory (for example, memory card). The microphone 67 receives input of voice of the user. The mobile phone 60 digitizes the voice which is input (analog data). The mobile phone 60 then transmits the voice which is digitized to a communication target (for example, another mobile phone). The speaker 68 outputs sound, for example, based on music data or the like stored in the RAM 73.

The touch panel system 1 has the touch panel 3, the touch panel controller 2 that detects an electrostatic capacitance or a difference of the electrostatic capacitance, and the stylus pen 15. The CPU 65 controls operation of the touch panel system 1. The display panel 70 displays an image stored in the ROM 72 or the RAM 73 by the display control circuit 71. The display panel 70 is overlapped with the touch panel 3 or incorporates the touch panel 3. Note that, a touch recognition signal which is generated by the touch recognition unit 10 to indicate a touch position on the touch panel 3 may have the same function as that of a signal indicating that the operation key 69 is operated.

### OVERVIEW

A method for detecting a touch panel position according to an aspect 1 of the invention is a method for detecting a touch panel position for detecting a position of a stylus pen (15) on a touch panel (3) which has M first signal lines (signal lines VL1 to VLM) (M is plural) and K second signal lines (signal lines HL1 to HLK) (K is plural) which intersect with the M first signal lines, and includes a first driving step of driving the stylus pen (15) to obtain a first pen signal based on electrostatic capacitances between the stylus pen (15) and the respective K second signal lines (signal lines HL1 to HLK); a second driving step of driving the stylus pen (15) to obtain a second pen signal based on electrostatic capacitances between the stylus pen (15) and the respective M first signal lines (signal lines VL1 to VLM); and a position detection step of detecting a position of the stylus pen (15) along a first signal line (signal lines VL1 to VLM) based on the first pen signal obtained at the first driving step and detecting a position of the stylus pen (15) along a second signal line (signal lines HL1 to HLK) based on the second pen signal obtained at the second driving step.

With the aforementioned configuration, since the position of the stylus pen along the first signal line is detected and the position of the stylus pen along the second signal line is detected at the position detection step, it is possible to detect a position of the stylus pen on the touch panel by driving the stylus pen.

In a method for detecting a touch panel position according to an aspect 2 of the invention, in the aforementioned aspect 1, in the first driving step, the M first signal lines (signal lines VL1 to VLM) and the stylus pen (15) may be driven in parallel based on (M+1) first coded sequences corresponding to m-sequences, and in the second driving step, the K second signal lines (signal lines HL1 to HLK) and the stylus pen (15) may be driven in parallel based on (K+1) second coded sequences corresponding to the m-sequences.

With the aforementioned configuration, it is possible to detect a position of the stylus pen on a touch panel of a parallel driving method.

In a method for detecting a touch panel position according to an aspect 3 of the invention, in the aforementioned aspect 2, the stylus pen (15) may have a pressure sensor (17) for detecting writing pressure, and polarities of the first coded sequences and the second coded sequences may be inverted based on an output of the pressure sensor (17).

Since the polarities of the coded sequences for driving are inverted based on the output of the pressure sensor which has detected touch to the touch panel, it is possible to discriminate a hover state where the stylus pen slightly hovers from the touch panel and a touch state where the stylus pen makes contact with the touch panel.

In a method for detecting a touch panel position according to an aspect 4 of the invention, in the aforementioned aspect 1, the M first signal lines (X0 to X24) and the stylus pen (15) are selected and driven successively at the first driving step, and the K second signal lines (Y0 to Y19) and the stylus pen (15) are selected and driven successively at the second driving step.

With the aforementioned configuration, it is possible to detect a position of the stylus pen on a touch panel of a successive driving method.

A touch panel controller according to an aspect 5 of the invention is a touch panel controller (2) for detecting a position of a stylus pen (15) on a touch panel (3) which has M first signal lines (signal lines VL1 to VLM) (M is plural) and K second signal lines (signal lines HL1 to HLK) (K is plural) which intersect with the M first signal lines, including: first driving means (driver 5) of driving the stylus pen (15) to generate a first pen signal based on electrostatic capacitances between the stylus pen (15) and the respective K second signal lines (signal lines HL1 to HLK); second driving means (driver 5) of driving the stylus pen (15) to generate a second pen signal based on electrostatic capacitances between the stylus pen (15) and the respective M first signal lines (signal lines VL1 to VLM); and position detection means (capacitance distribution calculation unit 9) of detecting a position of the stylus pen (15) along a first signal line (signal lines VL1 to VLM) based on the first pen signal output from the stylus pen (15) by the first driving means (driver 5) and detecting a position of the stylus pen (15) along a second signal line (signal lines HL1 to HLK) based on the second pen signal output from the stylus pen (15) by the second driving means (driver 5).

With the aforementioned configuration, since the position of the stylus pen along the first signal line is detected and the position of the stylus pen along the second signal line is detected by the position detection means, it is possible to detect a position of the stylus pen on the touch panel by driving the stylus pen.

A touch panel controller according to an aspect 6 of the invention is a touch panel controller (2) for detecting positions of first and second stylus pens on a touch panel (3) which has M first signal lines (signal lines VL1 to VLM) (M is plural) and K second signal lines (signal lines HL1 to HLK) (K is plural) which intersect with the M first signal lines, including:

first driving means (driver 5) of driving the first stylus pen to generate a first pen signal based on electrostatic capacitances between the first stylus pen and the respective K second signal lines (signal lines HL1 to HLK); second driving means (driver 5) of driving the first stylus pen to generate a second pen signal based on electrostatic capacitances between the first stylus pen and the respective M first signal lines (signal lines VL1 to VLM); and position detection means (capacitance distribution calculation unit 9) of detecting a position of the first stylus pen along a first signal line (signal lines VL1 to VLM) based on the first pen signal generated by the first driving means (driver 5) and detecting a position of the first stylus pen along a second signal line (signal lines HL1 to HLK) based on the second pen signal generated by the second driving means (driver 5), in which the first driving means (driver 5) drives the second stylus pen to generate a third pen signal based on electrostatic capacitances between the second stylus pen and the respective K second signal lines, the second driving means (driver 5) drives the second stylus pen to generate a fourth pen signal based on electrostatic capacitances between the second stylus pen and the respective M first signal lines, and the position detection means (capacitance distribution calculation unit 9) detects a position of the second stylus pen along a first signal line (signal lines VL1 to VLM) based on the third pen signal generated by the first driving means (driver 5) and detects a position of the second stylus pen along a second signal line (signal lines HL1 to HLK) based on the fourth pen signal generated by the second driving means (driver 5).

With the aforementioned configuration, the position of the first stylus pen along the first signal line is detected and the position of the first stylus pen along the second signal line is detected by the position detection means. Further, the position of the second stylus pen along the first signal line is detected and the position of the second stylus pen along the second signal line is detected. Thus, it is possible to detect positions of the first and second stylus pens on the touch panel by driving the first stylus pen and the second stylus pen.

A touch panel system according to an aspect 7 of the invention is a touch panel system (1) including a stylus pen (15) for touching a touch panel (3) which has M first signal lines (signal lines VL1 to VLM) (M is plural) and K second signal lines (signal lines HL1 to HLK) (K is plural) which intersect with the M first signal lines, and a touch panel controller (2) that detects a position of the stylus pen (15), in which the touch panel controller (2) includes: first driving means (driver 5) of driving the stylus pen (15) to generate a first pen signal based on electrostatic capacitances between the stylus pen (15) and the respective K second signal lines (signal lines HL1 to HLK); second driving means (driver 5) of driving the stylus pen (15) to generate a second pen signal based on electrostatic capacitances between the stylus pen (15) and the respective M first signal lines (signal lines VL1 to VLM); and position detection means (capacitance distribution calculation unit 9) of detecting a position of the stylus pen (15) along a first signal line (signal lines VL1 to VLM) based on the first pen signal generated by the first driving means (driver 5) and detecting a position of the stylus pen (15) along a second signal line (signal lines HL1 to HLK) based on the second pen signal generated by the second driving means (driver 5).

With the aforementioned configuration, since the position of the stylus pen along the first signal line is detected and the position of the stylus pen along the second signal line is detected by the position detection means, it is possible to detect a position of the stylus pen on the touch panel by driving the stylus pen.

In a touch panel system according to an aspect 8 of the invention, the stylus pen (15) may be driven by radio, and the stylus pen (15) may have a synchronization circuit (synchronization signal detection circuit 22) for synchronizing driving of the first signal lines (signal lines VL1 to VLM) or the second signal lines (signal lines HL1 to HLK) and driving of the stylus pen (15).

With the aforementioned configuration, it is possible to drive the first signal lines or the second signal lines and the stylus pen at the same time.

An electronic device (mobile phone 60) according to an aspect 9 of the invention includes the touch panel controller (2) according to the invention.

With the aforementioned configuration, since the position of the stylus pen along the first signal line is detected and the position of the stylus pen along the second signal line is detected by the position detection means, it is possible to obtain an electronic device capable of detecting a position of the stylus pen on the touch panel by driving the stylus pen.

The invention is not limited to each of the embodiments described above, and may be modified in various manners within the scope of the claims and an embodiment achieved by appropriately combining technical means disclosed in each of different embodiments is also encompassed in the technical scope of the invention. Further, by combining the technical means disclosed in each of the embodiments, a new technical feature may be formed.

### INDUSTRIAL APPLICABILITY

The invention is able to be used for a method for detecting a touch panel position and a touch panel controller that detect a position of an input pen on a touch panel which has a plurality of electrostatic capacitances formed at respective intersections of a plurality of first signal lines and a plurality of second signal lines, and is able to be used particularly for a method for detecting a touch panel position and a touch panel controller that drive the plurality of first signal lines and the plurality of second signal lines alternately.

### REFERENCE SIGNS LIST

1 touch sensor system
2 touch panel controller
3 touch panel
4 multiplexer
5 driver (first driving means, second driving means)
6 sense amplifier
7 timing generator
8 AD converter
9 capacitance distribution calculation unit (position detection means)
10 touch recognition unit
15 stylus pen
16 pen position detection unit
17 pressure sensor
21 sense circuit
22 synchronization signal detection circuit (synchronization circuit)
23 timing generator
24 operation changeover switch
25 operation changeover switch
26 drive circuit
27 pen point
VL1 to VLM signal lines (second signal lines)
HL1 to HLM signal lines (first signal lines)
C11 to CMM electrostatic capacitance
DL1 to DLM drive line
SL1 to SLM sense line

1-9. (canceled)

10. A method for detecting a touch panel position for detecting a position of a stylus pen on a touch panel which has M first signal lines (M is plural) and K second signal lines (K is plural) which intersect with the M first signal lines, the method comprising:
a first driving step of driving the stylus pen to obtain a first pen signal included in signals outputted from the second signal lines, the signals being based on electrostatic capacitances between the stylus pen and the respective K second signal lines;
a second driving step of driving the stylus pen to obtain a second pen signal included in signals outputted from the first signal lines, the signals being based on electrostatic capacitances between the stylus pen and the respective M first signal lines; and
a position detection step of detecting a position of the stylus pen along a first signal line based on the first pen signal obtained at the first driving step and detecting a position of the stylus pen along a second signal line based on the second pen signal obtained at the second driving step.

11. The method for detecting a touch panel position according to claim 10, wherein
in the first driving step, the M first signal lines and the stylus pen are driven in parallel based on (M+1) first coded sequences corresponding to m-sequences, and
in the second driving step, the K second signal lines and the stylus pen are driven in parallel based on (K+1) second coded sequences corresponding to the m-sequences.

12. The method for detecting a touch panel position according to claim 11, wherein
the stylus pen has a pressure sensor for detecting writing pressure, and
polarities of the first coded sequences and the second coded sequences are inverted based on an output of the pressure sensor.

13. The method for detecting a touch panel position according to claim 10, wherein
in the first driving step, the M first signal lines and the stylus pen are selected and driven successively, and
in the second driving step, the K second signal lines and the stylus pen are selected and driven successively.

14. A touch panel controller for detecting a position of a stylus pen on a touch panel which has M first signal lines (M is plural) and K second signal lines (K is plural) which intersect with the M first signal lines, the touch panel controller comprising:
first driving means of driving the stylus pen to generate a first pen signal included in signals outputted from the second signal lines, the signals being based on electrostatic capacitances between the stylus pen and the respective K second signal lines;
second driving means of driving the stylus pen to generate a second pen signal included in signals outputted from the first signal lines, the signals being based on electrostatic capacitances between the stylus pen and the respective M first signal lines; and
position detection means of detecting a position of the stylus pen along a first signal line based on the first pen signal generated by the first driving means and detecting a position of the stylus pen along a second signal line based on the second pen signal generated by the second driving means.

15. A touch panel controller for detecting positions of first and second stylus pens on a touch panel which has M first signal lines (M is plural) and K second signal lines (K is plural) which intersect with the M first signal lines, the touch panel controller comprising:
first driving means of driving the first stylus pen to generate a first pen signal included in signals outputted from the second signal lines, the signals being based on electrostatic capacitances between the first stylus pen and the respective K second signal lines;
second driving means of driving the first stylus pen to generate a second pen signal included in signals outputted from the first signal lines, the signals being based on electrostatic capacitances between the first stylus pen and the respective M first signal lines; and
position detection means of detecting a position of the first stylus pen along a first signal line based on the first pen signal generated by the first driving means and detecting a position of the first stylus pen along a second signal line based on the second pen signal generated by the second driving means, wherein
the first driving means drives the second stylus pen to generate a third pen signal based on electrostatic capacitances between the second stylus pen and the respective K second signal lines,
the second driving means drives the second stylus pen to generate a fourth pen signal based on electrostatic capacitances between the second stylus pen and the respective M first signal lines, and
the position detection means detects a position of the second stylus pen along a first signal line based on the third pen signal generated by the first driving means and detects a position of the second stylus pen along a second signal line based on the fourth pen signal generated by the second driving means.

16. An electronic device comprising the touch panel controller according to claim 14.

17. An electronic device comprising the touch panel controller according to claim 15.
